(19) United States
(12) Patent Application Publication
(10) Pub. No.: US 2008/0007809 A1
(43) Pub. Date: Jan. 10, 2008

(54) Auto-stereoscopic diffraction optics imaging system providing multiple viewing pupil pairs

(76) Inventor: Gaylord E. Moss, Marina del Rey, CA (US)

Correspondence Address: Carter, DeLuca, Farrell & Schmidt, LLP, Suite 225, 445 Broad Hollow Road, Melville, NY, 11747, US

(21) Appl. No.: 11/483,482

(22) Filed: Jul. 10, 2006

(51) Int. Cl. G03H 1/04

(52) U.S. Cl. 359/35; 359/15

(57) ABSTRACT

An autostereoscopic imaging system is disclosed that provides for a three dimensional display of an image to multiple observers simultaneously from a single pair of stereoscopic projectors. The system provides for high quality immersive imagery using a holographic diffractive optical element that is made and configured to contain multiple holograms of optical diffusers, each of the holograms having a common reference beam and being made with each diffuser in a different location. A pair of projectors placed astride the reference beam virtual focus projects a stereoscopic image onto the diffractive optical element, such that the plurality of holograms reconstructs multiple stereoscopic images at multiple locations corresponding to the location where the diffusers were previously located during the recording of each respective hologram. Methods of making the diffractive optical element with a plurality of holograms are also disclosed. The holograms may be made on separate plates and laminated together, or may be made by simultaneous, sequential, or repeated partial sequential exposures onto a single holographic plate.

### BACKGROUND

1. Technical Field

The present disclosure describes a system for a three dimensional display for multiple observers, and, in particular, a system that provides stereo imagery for multiple observers without the need for special glasses or goggles.

2. Description of the Related Art

Stereoscopic imaging systems are well known in the art. Many stereoscopic imaging systems require the user to wear a device in order to view a stereoscopic image. Such devices enable the user to see a different image with each eye so that the user perceives depth from the disparate images seen by both eyes. For long-term use, such viewing attachments may cause discomfort and fatigue.

There are well-known stereo display techniques better suited to long-term use because they do not require the wearing of any attachments. Such displays are called autostereoscopic. One such is the well-known use of lenticular molded lenses in a sheet such as is used in postcards to show stereo still images. A similar technique is used with CRT or liquid crystal screens to show stereo video images. Other similar displays replace the lenticular elements with masking bars or illumination bars to select a different set of strip images to create a different view for each eye. These systems all lose at least half of the available image resolution in displaying both images. In addition, as the user moves out of a limited viewing area, the images are sent to the opposite eyes, reversing the depth of the image, which is very disturbing to the user.

A better solution for displaying stereo images, which also uses no viewing attachments and does not have the loss of resolution and other problems of the lenticular-type screens, is described in U.S. Pat. No. 4,799,739 by Newswanger (hereinafter “Newswanger”).

Newswanger describes the use of a diffractive optical element to separate two images projected onto a screen, directing each to the appropriate eye to give autostereoscopic vision. This allows the use of the full screen area for each eye's image thus incurring no resolution loss. This system provides autostereoscopic viewing for one viewer with the limitation that the viewer must position himself so that each eye is in the image pupil in the space to which the diffraction optical element directs the image.

This system also permits the construction of more than one viewing set of pupils so that more than one person can see the stereo image at one time. This is done by placing, for each viewer, an additional pair of projectors at a different angular position relative to the diffractive optical element. Each pair of projectors generates a new pair of viewing pupils at a different angle to the diffractive optical element screen. The downside of this technique is the cost, bulk and complexity of the additional pair of projectors required for each viewing position.

### SUMMARY

This disclosure teaches a method to make an autostereoscopic imaging system which has the advantages of Newswanger but that allows multiple observers to see the display without the need for an additional pair of projectors for each observer. Only a single pair of projectors is needed for any number of observers; the allowable number of observers is mainly limited by the space available in front of the screen. Larger screens can accommodate more observing positions.

The imaging system of the present disclosure, when made as a transmission imaging system, employs a diffraction optical element that includes the holographic image of a diffuse pupil area constructed with a reference beam that converges to a point. The diffraction optical element is used as a display screen by projecting an image onto the diffraction optical element from the point of convergence of the constructing reference beam. The image-forming projection beam becomes a reversed reference beam forming a real image of the diffuse viewing pupil area that was holographically recorded. The effect is that the light from any point on the diffraction optical element is spread over the area of the diffuse screen real image. Since the diffraction optical element illumination is the image that is projected on it, the result is that an observer's eye anywhere in the real diffuser image area will see the full image projected on the screen diffracted into that area. Outside of the image screen area, there is no diffracted image. The autostereoscopic display is created by using two projectors to focus both the left and right eye images onto the diffraction optical element from angles offset from the point focus of the original reference beam. The diffraction optical element reconstructs each image projection to form separate real images of the diffusion screen with each image offset from the other. Each eye of an observer positioned at a viewing pupil area in each image will see only the image that was projected from one of the projectors. Thus, an observer can place one eye in each diffusion image and see a stereo view if each projector focuses on the diffraction optical element screen the correct stereo image for that eye.

In order for more than one person to observe the image, the diffraction optical element is made to contain holograms of more than one diffuser, all made with the same reference beam. Each diffuser is placed at a different location during recording, so that a left and a right eye set of viewing pupil areas, as described above, is created at each place where a diffuser was located when it was recorded in the hologram. Each viewing pupil is a recreation of an offset image of the diffuser created by the hologram utilizing the illumination incident upon the diffraction optical element from one of the projectors. Thus, one pair of projectors creates stereo viewing pupils centered on each diffuser holographic exposure position. The multiple stereo viewing positions makes it possible for a number of observers, equal to the number of holographically recorded diffusers, to simultaneously see the display. Thus, the present system provides that multiple observers may simultaneously see a stereo image using only a single projector pair.

### BRIEF DESCRIPTION OF THE DRAWINGS

The above and other aspects, features, and advantages of the present disclosure will become more apparent in light of the following detailed description when taken in conjunction with the accompanying drawings in which:

FIGS. 1A and 1B are side and top views, respectively, of a schematic illustration of an exposure configuration that may be used to produce a diffraction optical element for use in an auto stereoscopic display system for a single user;

FIGS. 2A and 2B are top and side views, respectively, of a playback configuration of the display system in which one diffuser is recorded into the diffraction optical element using the setup of FIGS. 1A and 1B;

FIGS. 3A and 3B are side and top views, respectively, of a schematic illustration of the exposure configuration of FIGS. 1A and 1B with the diffuser position changed to make another viewing pupil pair in playback for a second user;

FIGS. 4A and 4B are top view and side views, respectively, of a playback configuration of the display system in which two diffuser recordings are incorporated into the diffraction optical element using setups of FIGS. 1A and 1B and FIGS. 3A and 3B;

FIGS. 5A and 5B are top view and side views, respectively, of an alternate embodiment in which a mirror is placed behind the transmission diffraction optical element of FIG. 4 to transform the diffraction optical element function into that of a reflection imaging display in which the projectors are on the same side of the diffraction optical element as the viewer and the diffracted stereo image;

FIG. 6A is a schematic view of an alternate embodiment illustrating a method to illuminate multiple diffusers using switchable mirrors for exposure of a multiple viewer diffraction optical element to send the object illumination selectively to any of the diffusers;

FIG. 6B is a schematic view of an alternate embodiment illustrating a method to expose all the diffusers at once with the option of exposing them individually by blocking beams with switchable shutters;

FIG. 6C is a schematic view of an alternate embodiment illustrating a method to expose the diffusers either simultaneously or individually with multiple lasers;

FIG. 6D is a schematic view of an alternate embodiment illustrating three diffusers selectively receiving object beams for exposure of the diffractive optical element;

FIG. 7A illustrates a configuration to combine three lasers along the same axis for simultaneous holographic exposure with multiple lasers; and

FIG. 7B is a schematic view of an alternate embodiment illustrating a method to combine the beams from multiple lasers so that the combined beam from all lasers exposes the diffuser either simultaneously or individually, which is particularly useful in making exposures with multiple wavelengths.

### DETAILED DESCRIPTION

Embodiments of the presently disclosed imaging system will be described below with reference to the accompanying drawing figures wherein like reference numerals identify similar or identical elements. In the following description, well-known functions or constructions are not described in detail to avoid obscuring the disclosure in unnecessary detail.

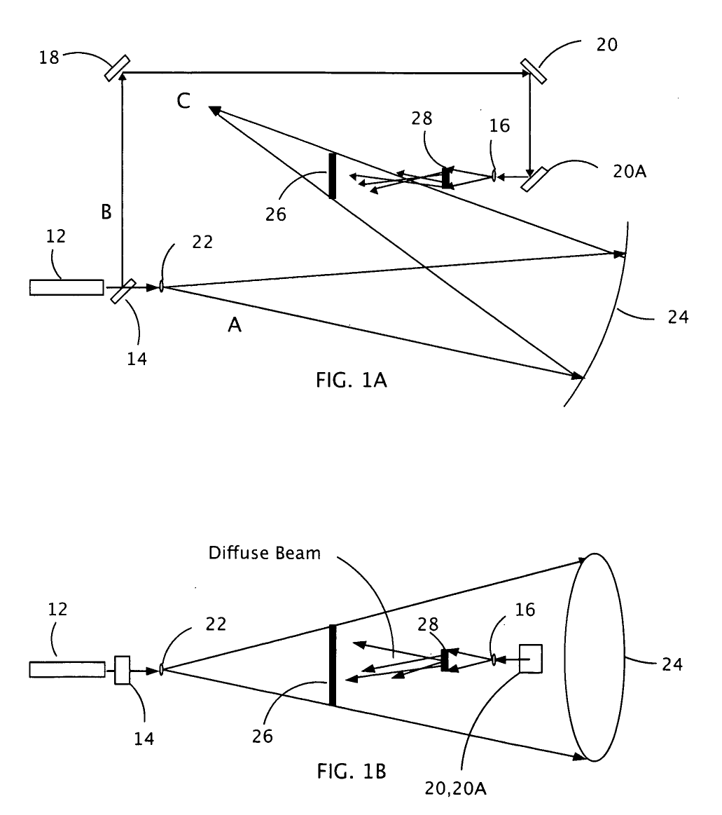

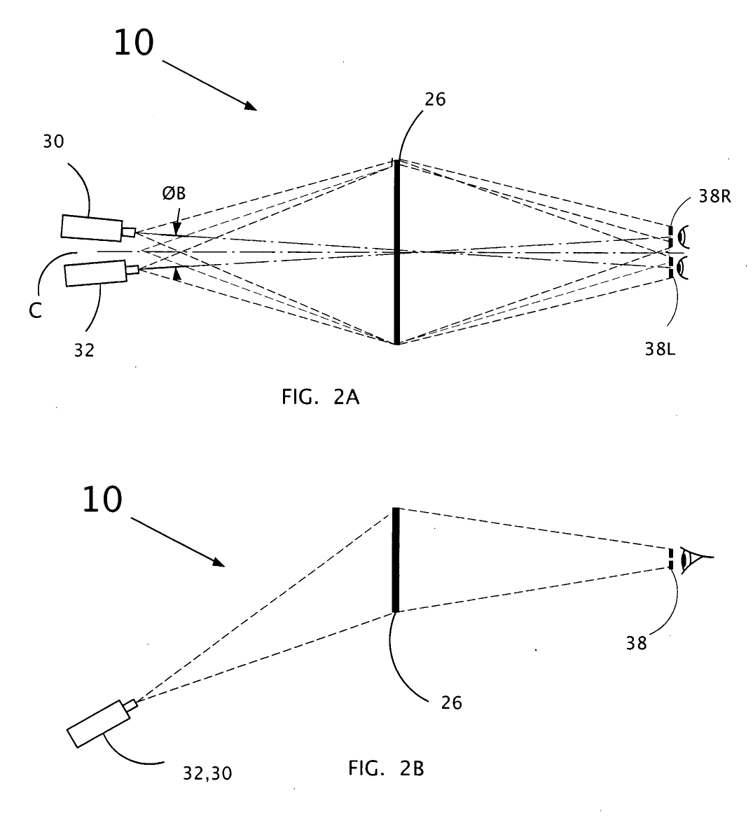

This disclosure describes an autostereoscopic imaging system 10 for showing a three dimensional image. One embodiment makes use of multiple transmission holographic images of separate diffusers which are combined to form a diffraction optics imaging system. FIGS. 1A and 1B show top and side views, respectively, of an optical setup for recording one diffuser 28 into a holographic recording plate 26 that may be processed, as necessary or appropriate, to form a diffraction optical element 26 (see FIG. 2A). As shown in FIG. 1A, the beam from laser 12 is split by beam splitter 14 with one of the resulting beams (B) directed by mirrors 18, 20 and 20A to spatial filter 16 where it is expanded to illuminate the transmission diffuser 28. The other beam (A) passes through the beam splitter to spatial filter 22 where it is expanded to illuminate the concave mirror 24. The reflected beam from mirror 24 converges toward a focus at point C but is intercepted by the recording plate 26. The holographic plate 26 thus records the interference pattern between the reference beam (A) converging toward C and the diffuse beam coming from diffuser 28. The diffuse beam is shown as a number of arrows for illustration purposes to show the diffusion of the light. Many types of diffusers may be used, such as surface ground glass, opal glass, translucent plastic, micro-lenses or holographic optical elements designed to direct all the diffuse light onto the recording plate. For full color playback, one can set the diffuser at the achromatic angle so that all colors from the projector overlap in the same viewing pupil. This angle can be found by using the grating equation or holographic equations to determine the points of origin for rays of different wavelengths that reconstruct the diffuser. These points lie in a straight line defining the achromatic angle to which the diffuser is aligned for full color reproduction.

FIGS. 2A and 2B show top and side views, respectively, of how the diffractive optical element 26 containing a single hologram made in accordance with FIGS. 1A and 1B functions as an autostereoscopic imaging system. As shown, two projectors, 30 and 32, project separate left and right eye views from points disposed on each side of the virtual focus point C. The pair of projectors 30, 32 are generally placed at or near or astride the reference beam virtual focus point C. Astride means that the projectors 30, 32 are situated on opposite sides of the reference beam virtual focus point C or are disposed lying across or disposed partially over the reference beam virtual focus point C, or disposed in proximity to the reference beam virtual focal point C. In another embodiment, the projectors 30, 32 may be placed away from the virtual focus point C, but be arranged with a reflector or mirror (not shown) astride the reference beam virtual focus point C so the projectors 30, 32 project to the mirror or reflector and still project from the reference beam virtual focus point C onto the diffraction optical element 26. Each projector 30, 32 is displaced sufficiently so that the distance between their beams at the viewing pupil distance from the diffractive optical element 26 is equal to the distance between the average observer's eyes. For a viewing pupil distance of 26 inches from the diffractive optical element 26 and an eye spacing of 2.7 inches, this gives an angular offset for each projector of 3 degrees relative to the center line perpendicular to the diffractive optical element 26 through focus point C. Because the projector beams are, in effect, replaying a reverse of the reference beam that was used to record the diffuser 28, it reconstructs a real image of the diffuser 28 at location 38. Because each projector 30, 32 is slightly off the axis of the original reference beam, the diffuser 28 reconstruction includes two side-by-side real diffuser images, 38L and 38R. The diffracted light coming from projector 30, generates the diffuser image 38L for the left eye of the observer and the diffracted light coming from projector 32, generates the diffuser image 38R for the right eye of the observer. These diffuser images form the viewing pupils of the system 10. The diffracted light from each point on the diffraction optical element 26 is spread uniformly inside one or the other of the pupils. (38R or 38L). It will be appreciated that the projected image of each projector, which is slightly off axis, may be optically corrected for distortion introduced as a result of this orientation, e.g., to correct for keystone distortion and sideways distortion.

When an observer views the scene on the diffraction optical element 26 with one eye in one pupil and one in the other, each eye sees the picture from a different projector and thus will see a stereoscopic image. Thus, the recording on the recording plate 26 of a single diffuser 28, when processed and illuminated with two angled projectors 30 and 32, creates an autostereoscopic image for a single observer. It is the purpose of this disclosure to show that providing properly exposed multiple holograms of diffusers in the same diffraction optical element, when illuminated with projectors 30 and 32 create additional viewing pupils at other locations.

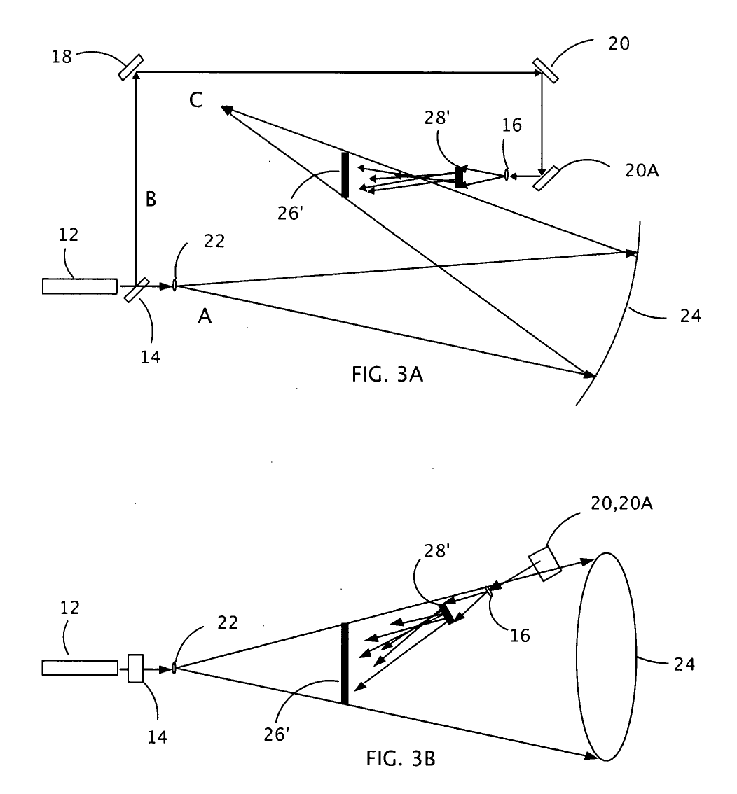

FIGS. 3A and 3B illustrate a method of adding second left and right eye viewing pupil pairs for another observer. The recording setup of FIGS. 3A-3B is identical to that of FIGS. 1A-1B except that the second diffuser 28′ is located at the same distance from recording plate 26 as was diffuser 28 but at a different angular position relative to the laser axis (e.g., compare FIG. 1B and FIG. 3B). This new diffuser 28′ is recorded into a new plate 26′ located identically with the former position of plate 26.

The complete diffraction optics element 34 is made by laminating this new recording plate 26′ containing the holographic recording of diffuser 28′ to the previous plate 26 which contains the holographic image of diffuser 28. Of course, additional recordings can be made of diffusers in still different angular locations relative to laser axes than either the locations of diffusers 28 or 28′. Thus a predetermined number of recorded diffuser images can be stored in a many-layered laminated diffraction element 34. One way to make the lamination is to remove the thin recording films from their substrates and to bond them all to a single glass substrate so that they diffract incident light from substantially the same plane. Less preferably, it is contemplated and within the scope of the present disclosure that a number of glass substrates each supporting a hologram may be laminated together to form the diffraction optical element 34.

An alternate method to make such an element is to record all the diffuser images in the same recording film plate 26. This may be done by setting up all the diffusers at once and illuminating and recording them simultaneously. Alternatively, they can be recorded sequentially, increasing the recording energy, power or time, with each exposure to account for the diminishing available recording index or film sensitivity as the recordings progress, thus keeping the diffraction efficiency of each image equal. A more sophisticated alternative to adjusting the exposure energy is to interleave the exposures in short bursts so that all the diffuser images build up gradually and together so that they all see the same changing recording material sensitivity. Another benefit of building up the exposures sequentially is to reduce the crosstalk between recordings that occurs in simultaneous recording.

Referring now to FIGS. 3A and 3B, there are shown side and top views, respectively, of the system for recording diffuser 28′ having a second position as is shown in the side view into another holographic plate 26′. As can be seen from FIGS. 3A and 3B, the second diffuser 28′ has a second angular position different from the position of diffuser 28 of FIGS. 1A and 1B.

As shown, the beam from laser 12 is split by beam splitter 14 with one of the resulting beams (B) directed by mirrors 18, 20 and 20A to spatial filter 16 where it is expanded to illuminate the second transmission diffuser 28′ having the second position. The other beam (A) passes through the beam splitter to spatial filter 22 where the beam is then expanded to illuminate the concave mirror 24. The reflected beam from mirror 24 converges toward a focus at point C but the beam is intercepted by the recording plate 26′. The holographic plate 26′ thus records the interference pattern between the reference beam (A) converging toward C and the diffuse beam coming from diffuser 28′. It should be appreciated that the imaging system 10 can accommodate any number of observers simply by incorporating additional holograms of more diffusers corresponding to additional viewing pupils.

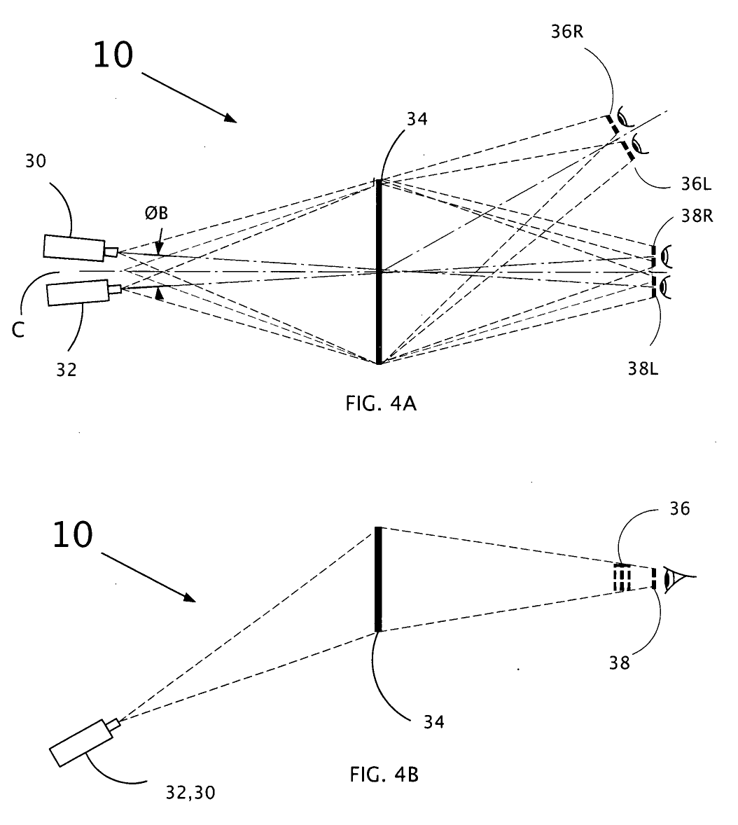

In FIG. 4, the combined, laminated diffractive optical element 34 contains the holographic images of both diffuser 28 and 28′. FIGS. 4A-4B illustrate that when the combined diffractive optical element 34 is illuminated with the same two projectors 30 and 32, four real pupil images are reconstructed; left and right images at viewing pupil 38 and left and right images at viewing pupils 36. The new viewing pupils 36 are located at the position of the second diffuser illustrated in FIGS. 3A-3B. The addition of another diffuser holographic image 28′ creates new viewing pupils where an additional observer may see the auto-stereoscopic image. By including the diffuser images, 28 and 28′, in a single diffraction optics element, two observers can see the auto-stereo images at the same time. The two diffuser images can be combined in the same diffractive optical element 34, either by making recordings on separate films and laminating them together or by recording both holograms in the same film layer. The advantage of laminating together diffractive optical elements in separate films is that the full available index modulation for the diffraction element is available for each set of viewing pupils, which increases the diffraction efficiency. Conversely, the advantage of recording all diffractive optical elements in a single film is that, in spite of the loss of diffraction efficiency caused by the sharing of modulation index, the process of laminating the films is eliminated.

It will be appreciated that more diffusion screens can be recorded, either all in a single film layer or in individual laminated layers. It should be appreciated that all recorded diffusers need not be identical. Each diffuser may differ in size, shape, angle or distance from the diffraction optical element. These differences could achieve aims such as a different viewing distance, different eye spacing, or optimum viewing area at the new angular position from the diffraction optical element. The limit on the number of observers for a single screen is set by the space in front of the imaging system to fit the observers shoulder to shoulder. Larger screens will accommodate more viewers. Techniques such as rows of users at different levels or distances could expand the number further.

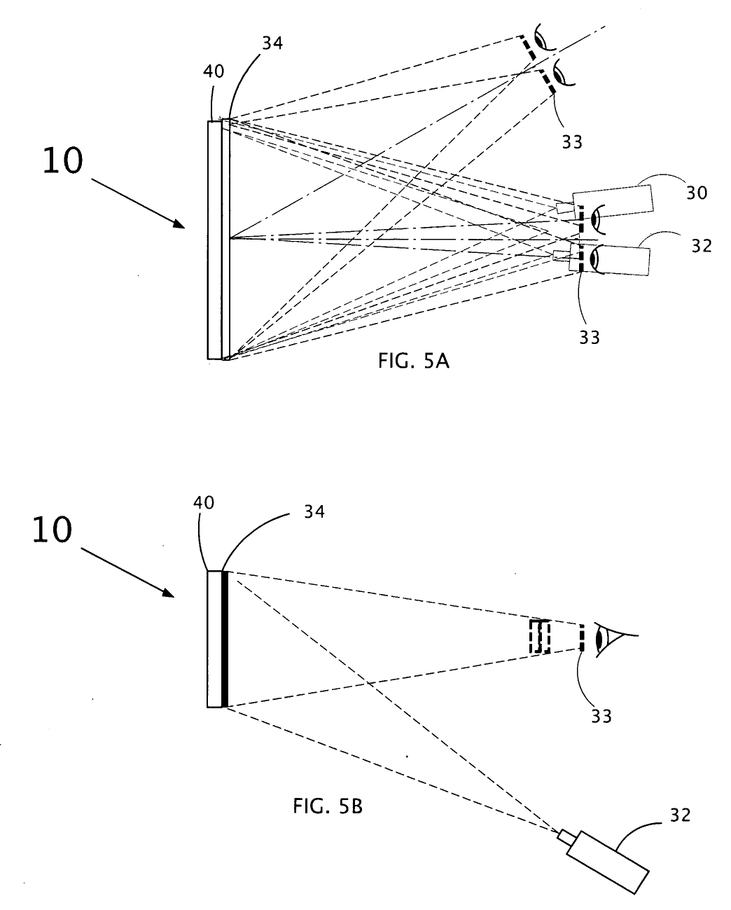

In an alternative embodiment shown in FIGS. 5A and 5B, the transmission holographic element 34 may be used in a reflection mode. FIGS. 5A and 5B show a top view and a side view, respectively, of the transmission holographic element in a reflection mode. With a mirror 40 situated behind the holographic diffractive optical element 34, the projector pair 30 and 32 may be placed at the reflected virtual focal point C of the reference beam A on the same side as the observer, thereby providing a viewing pupil pair 33 in a reflection system.

In a further alternative embodiment, the holograms of any or all of the foregoing embodiments may be made as actual reflection holograms. The method of making a reflection diffractive optical element 34 includes the placement of the source of the reflection and object beams on the opposite sides of the hologram to be constructed. For the systems described it is only necessary to reverse the reference beam along its axis.

Either of these methods for operating in reflection mode can be used for cases in which it is desired to place the projectors 30, 32 in front of the diffraction element on the same side as the observer. The advantage of the transmission mode with mirror method is that a transmission diffractive optical element 34 can be made with a single laser wavelength and still show full color images. It should be appreciated that in the reflection mode, the Bragg wavelength condition requires that a different diffractive optical element 34 be made for each wavelength to be efficiently diffracted, e.g., a different hologram for at least red, green and blue wavelengths to provide a full color display.

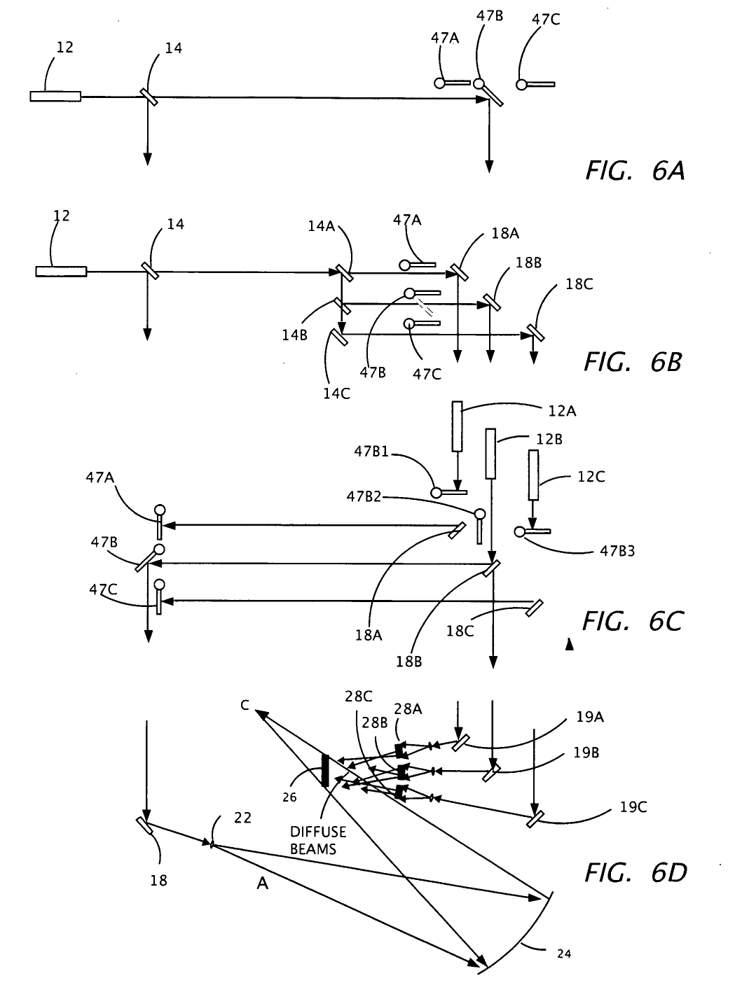

The exposures of multiple diffusers 28, 28′ can be made in various ways. FIGS. 6A through 6D show some specific examples. FIG. 6D shows an example optical layout for exposing three separate diffusers, 28A, 28B and 28C. For exposure, each of these diffusers 28A, 28B and 28C are illuminated with a beam which is coherent with the reference beam that converges to point C. The operation of this layout has been described previously for FIGS. 1A and 1B.

FIG. 6A shows one way to illuminate the diffusers 28A, 28B and 28C. As shown, the beam from laser 12 is split by beam splitter 14 with one beam reflecting down to mirror 18 to form the reference beam A which is expanded by spatial filter 22 and reflected from concave mirror 24 and converges at point C. The beam that passes through beam splitter 14 passes to the switchable mirrors 47A, 47B, and 47C. Any one of these mirrors 47A, 47B, and 47C can be switched to send a beam to strike one of the mirrors 19A, 19B, and 19C to illuminate one of the diffusers 28A, 28B or 28C. The holographic plate 26 can thus be exposed with each diffuser object beam turned on either sequentially or in interleaved multiple burst mode as described previously. As an example, in FIG. 6A, mirror 47B is switched into the path of the coherent beam to expose diffuser 28B. An advantage of either of these methods is that there is no recorded crosstalk between the three diffuser beams since only one is on at any given time.

FIG. 6B shows a layout in which all the diffusers 28A, 28B, and 28C can be illuminated and recorded simultaneously. The beam splitter 14A is made to transmit 33% of the incoming light, reflecting the other 66%. The 50% beam splitter 14B splits this 66% into two 33% beams. Each diffuser 28A, 28B, 28C, individually is thus illuminated with 33% of the laser output by way of mirrors 18A, 18B and 18C directing the light to mirrors 19A, 19B and 19C, respectively. If it is desired to expose the diffusers 28A, 28B, and 28C individually, the two unwanted beams may be blocked by the shutter switches shown at 47A, 47B, and 47C while one switch allows the selected beam to go on to mirror 19A, 19B, or 19C. The disadvantage of this layout compared with that of FIG. 6A is that, in this method, only 33% of the laser power transmitted by beam splitter 14 is available to expose each diffuser 28A, 28B, and 28C, while for the method of FIG. 6A, all of the power transmitted through beam-splitter 14 is available for exposing each diffuser 28A, 28B, and 28C.

FIG. 6C shows a layout in which separate lasers 12A, 12B, and 12C illuminate each diffuser 28A, 28, and 28C. Each laser 12A, 12B, and 12C has its own beam-splitter 18A, 18B, and 18C so that the reference and object beams are mutually coherent. It is, however, possible to use the same reference beam if the several lasers 12A, 12B, and 12C are phase locked together. This embodiment shows individual switchable beam blockers 47B1, 47B2 and 47B3 to allow individual exposures either sequentially or interleaved as previously described. The opening of one of these beam blockers 47B1, 47B2 and 47B3 would be coupled to the opening of the associated mirror 47A, 47B or 47C. In the example shown, beam blocker 47B2 is opened letting the beam reflected from beam splitter 18B travel to opened mirror 47B to generate the reference beam A (FIG. 6D). Simultaneously, the beam that passes through beam-splitter 18B passes to mirror 19B to illuminate the diffuser 28B. Various configurations are possible and within the scope of the present disclosure.

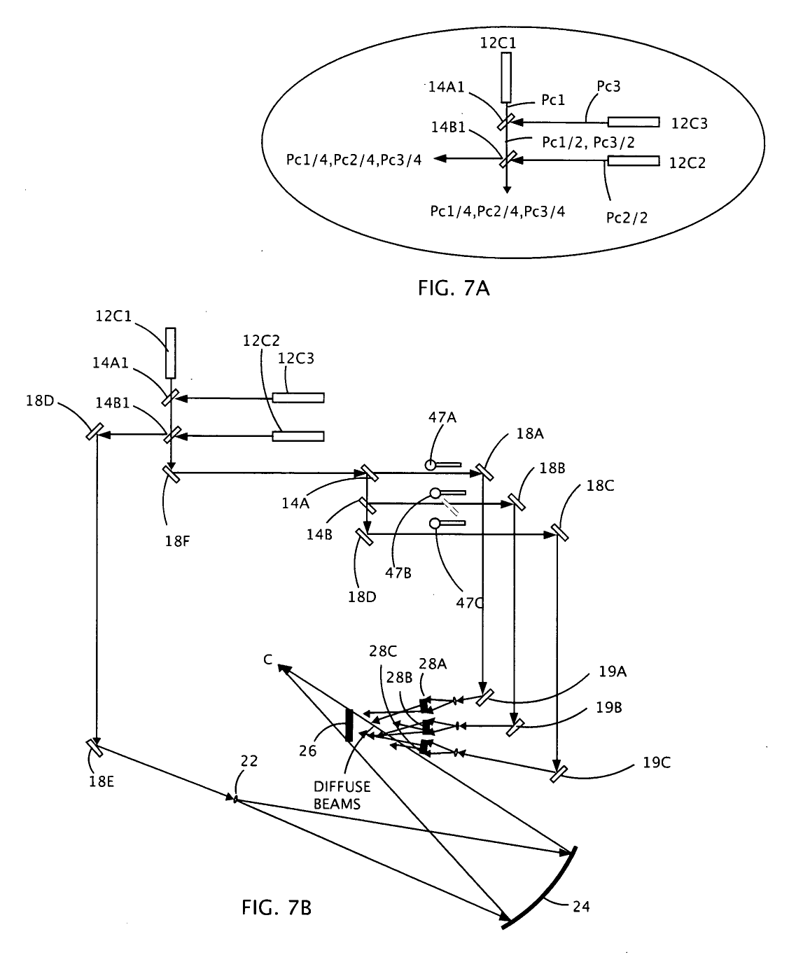

FIGS. 7A and 7B shows an arrangement in which each diffuser 28A, 28B and 28C is illuminated by each of the three lasers 12C1, 12C2 and 12C3. FIG. 7A shows how the 50% beam-splitters 14A1 and 14B1 combine the three lasers 12C1, 12C2 and 12C3 so that, if laser 12C2 has half the power of each laser 12C1 and laser 12C2, then both the transmitted and reflected beams from beam-splitter 14B1 have equal parts of one quarter of the power in each beam.

The operation is shown in FIG. 7B. in which, the reflected beam from beam splitter 14B1 (FIG. 7B ) is directed by mirrors 18D and 18E to spatial filter 22 to illuminate the mirror 24 and provide a reference beam that converges to point C. The beam transmitted through the beam splitter 14B1 is directed by mirror 18F to 33% transmission beam splitter 14A so that the transmitted 33% of the incident power is sent by mirrors 18A and 19A to illuminate diffuser 28A. The reflected beam from beam splitter 14A is split by 50% beam splitter 14B to send 33% of the power to each of the diffusers 28B and 28C. The switchable beam blockers 47A, 47B and 47C may be used to expose each of the diffusers 28A, 28B, and 28C separately, each with all three lasers 12C1, 12C2, and 12C3. It may be appreciated that if the lasers 12C1, 12C2, and 12C3 have substantially different wavelengths, greater efficiency can be achieved by replacing all beam-splitters with dichroic devices that operate selectively on each wavelength.

From the foregoing and with reference to the various figure drawings, those skilled in the art will appreciate that certain modifications can also be made to the present disclosure without departing from the scope of the same. For example, although the specific embodiment of the disclosure uses two projectors to focus the two images of a stereo pair onto the diffraction element from different angles of projection, it should be understood that other methods such as a single projector with a split image source sending the stereo images from separate lenses or mirrors in a single projector is also anticipated as is any other means of forming the focused image on the diffraction element from different directions for each of the stereo images.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of preferred embodiments.

What is claimed is:

1. An autostereoscopic imaging system comprising:
a holographic diffractive optical element containing a plurality of diffractive holograms, each said hologram having a common reference beam and each said hologram including a recording of a separate diffuse object; and
a pair of projectors positioned substantially at the reference beam virtual focal point, such that light from stereoscopic images projected by said pair of projectors onto the holographic diffractive optical element is directed by each hologram to separate areas centered on the initial diffuse object location during generation of the holographic diffractive optical element.

2. The system of claim 1 wherein said holographic diffractive optical element further comprises multiple holograms laminated together.

3. The system of claim 1 wherein said holographic diffractive optical element further comprises a single holographic plate containing multiple holograms.

4. The system of claim 1 wherein said holograms are transmission holograms.

5. The system of claim 4 further comprising a mirror adjacent said holographic diffractive optical element, such that said pair of projectors is disposed on the same side of the holographic diffractive optical element as the viewer.

6. A system for displaying a three dimensional image for simultaneous viewing by multiple viewers, comprising:
a holographic diffractive optical element having multiple holograms of an optical diffuser;
a pair of projectors for projecting a stereoscopic image onto the holographic diffractive optical element, the projector pair and the holographic diffractive optical element arranged and configured such that each hologram of the holographic diffractive optical element reconstructs an image of the corresponding diffuser utilizing light from the projector thereby creating a pair of stereoscopic viewing pupils corresponding to each hologram.

7. The system of claim 6, wherein said holographic diffractive optical element further comprises a plurality of holographic diffractive plates laminated together.

8. The system of claim 7, wherein said holographic diffractive optical element comprises a holographic plate containing multiple diffractive holograms.

9. The system of claim 6, wherein said holograms are transmission holograms.

10. The system of claim 6, wherein said holographic diffractive element are reflection holograms.

11. A method of making a system to display a stereoscopic image comprising:
making a plurality of diffractive holograms, each said hologram having a common reference beam, each said hologram recording a separate and distinct diffuse object; and
processing the holograms such that the holograms are contained in a single holographic diffractive optical element, the holograms configured and arranged such that light from the two views of a stereoscopic image projected onto the holographic diffractive optical element are directed by each hologram to separate viewing pupils.

12. The method of claim 11 wherein the step of making a plurality of holograms further comprises making at least two holograms, each said hologram having the same reference beam and a different object beam.

13. The method of claim 12 wherein the step of making a plurality of holograms further comprises making separate holograms on separate holographic plates.

14. The method of claim 13 further comprising laminating the processed holographic plates together to form the holographic diffractive optical element.

15. The method of claim 12 wherein the step of making a plurality of holograms further comprises making multiple holograms in a single holographic plate.

16. The method of claim 15 wherein the step of making a plurality of holograms further comprises making a first holographic exposure onto said holographic plate and thereafter making at least one additional holographic exposure onto said holographic plate.

17. The method of claim 15 wherein the step of making a plurality of holograms further comprises making a first partial holographic exposure onto the holographic plate, followed by a first partial exposure of at least one additional hologram onto said plate, and thereafter alternating partial sequential exposures of said plurality of holograms until the holographic exposures are complete.

18. The method of claim 12 wherein said step of making a plurality of holograms further comprises:
positioning a first holographic plate at a first location for exposure:
making a first hologram of an optical diffuser in the first holographic plate using a first reference beam and a first object beam;
removing the first holographic plate;
positioning a second holographic plate at the first location for exposure;
making a second hologram of an optical diffuser in the second holographic plate using a second reference beam substantially identical to the first reference beam and a second object beam that is different from the first object beam;
processing the holograms;
combining the processed holograms to form the holographic diffractive optical element.

19. The method of claim 11, wherein said holograms are transmission holograms.

20. The method of claim 11, wherein said holograms are reflection holograms.

21. The method of claim 11, wherein each said hologram is made at a single wavelength of light.

22. The method of claim 11, wherein each said hologram is made using multiple wavelengths of light.

23. The method of claim 11, wherein each said hologram is made using three wavelengths of light.

24. The method of claim 11, wherein each said hologram is a hologram of a diffractive optical glass plate.

25. The method of claim 11, wherein said hologram is a hologram of an opal glass plate.

26. The system of claim 6, wherein the holographic diffractive optical element further divides the images projected by the pair of stereoscopic projectors into a first image and a second image and directs light from each image to one of the pupils enabling stereoscopic viewing at the pupil pair.

27. The system of claim 6, further comprising the step of reducing optical distortion of the images projected onto the diffraction optical element.

28. The system of claim 1, wherein the separate areas are spaced so that the centers of the areas are spaced substantially as the spacing between the eyes of an observer.

29. A system for displaying a three dimensional image for simultaneous viewing by multiple viewers, comprising:
a holographic diffractive optical element having multiple holograms of an optical diffuser; and
a projector configured to project a stereoscopic image onto the holographic diffractive optical element, the projector and the holographic diffractive optical element arranged and configured such that each hologram of the holographic diffractive optical element reconstructs an image of the corresponding diffuser utilizing light from the projector thereby creating a pair of stereoscopic viewing pupils corresponding to each hologram.

30. A system for displaying a three dimensional image for simultaneous viewing by multiple viewers, comprising:
a holographic diffractive optical element having multiple holograms of a holographic diffuser; and
means for forming focused images of a stereo pair onto the holographic diffractive optical element with light from each of the stereo pairs striking a holographic film from a different source angle.
